(19) United States
(12) Patent Application Publication
(10) Pub. No.: US 2026/0302665 A1
(43) Pub. Date: Oct. 1, 2026

(54) CARD EDGE CONNECTOR WITH A DETECTING OPENING

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: TONG-SHENG XUE, Kunshan (CN); ZHUANG-XING LI, Kunshan (CN); WEN-JUN TANG, Kunshan (CN); XUE-WU BU, Kunshan (CN)

(21) Appl. No.: 19/635,715

(22) Filed: Mar. 31, 2026

(30) Foreign Application Priority Data
Apr. 1, 2025 (CN) 202520599902.5

(51) Int. Cl. H01R 12/72; H01R 12/70; H01R 13/502; H01R 13/627; H01R 13/641

(52) U.S. Cl. CPC H01R 12/721; H01R 12/7023; H01R 13/502; H01R 13/6272; H01R 13/641

(57) ABSTRACT

A card edge connector includes a longitudinal insulative housing having a longitudinal direction and a card slot for receiving an electronic card, plural conductive terminals received in the insulative housing, a first raised portion and a second raised portion respectively extending from opposite ends of the insulative housing, a latch member pivotally connected to the first raised portion, a cover member fixed above the second raised portion, and a locking member fixed in the second raised portion and facing the card slot. A passage extends from the second raised portion and to the cover member, the cover member has an opening communicating with the passage, the locking member is received in the passage and is deformable in the longitudinal direction, and a part of the locking member is visible through the opening after the locking member deforms away from the card slot in the longitudinal direction.

### BACKGROUND OF THE INVENTION

### Field of the Invention

The present invention relates to a card edge connector.

### Description of Related Arts

U.S. Pat. No. 9,634,430 discloses a card edge connector for insertion of an electronic card. The card edge connector includes a base housing having a terminal insertion portion and two clamping portions. An elastic clamping part is fastened to one of the clamping portions. The elastic clamping part includes a fastening base, an elastic arm, an elastic resisting portion and a limiting portion. Each of two opposite sides of the fastening base has a retaining portion to be retained in the clamping portion. When the insertion card moves along the limiting slot and is inserted to the card edge connector, a front edge of the insertion card will resist against an inclined section of the elastic resisting portion.

### SUMMARY OF THE INVENTION

An object of the present invention is to provide a card edge connector having a visible function.

In order to achieve above-mentioned object, a card edge connector includes a longitudinal insulative housing having a longitudinal direction and a card slot for receiving an electronic card, a plurality of conductive terminals received in the insulative housing, a first raised portion and a second raised portion respectively extending from opposite ends of the insulative housing in the longitudinal direction, a latch member pivotally connected to the first raised portion, a cover member fixed above the second raised portion, and a locking member fixed in the second raised portion and facing the card slot. A passage extends from the second raised portion and to the cover member, the cover member has an opening communicating with the passage, the locking member is received in the passage and is deformable in the longitudinal direction, and a part of the locking member is visible through the opening after the locking member deforms away from the card slot in the longitudinal direction.

Other objects, advantages and novel features of the present invention will become more apparent from the following detailed description of the present embodiment when taken in conjunction with the accompanying drawings.

### BRIEF DESCRIPTION OF DRAWINGS

FIG. 1 is a perspective view of a card edge connector inserted with an electronic card of an embodiment of the present application;

FIG. 2 is a perspective view of the card edge connector of FIG. 1;

FIG. 3 is an exploded perspective view of FIG. 2;

FIG. 4 is perspective view of a part of the card edge connector inserted with the electronic card of FIG. 1;

FIG. 5 is a perspective view of a cover member of FIG. 3;

FIG. 6 is a cross sectional view to show a normal locked state of the card edge connector inserted with the electronic card;

FIG. 7 is a perspective view of FIG. 6, to show the detecting opening;

FIG. 8 is a cross sectional view to show an abnormal locked state of the card edge connector inserted with the electronic card.

FIG. 9 is a perspective view of FIG. 8, to show the detecting opening;

FIG. 10 is a side view of the locking member of FIG. 2;

FIG. 11 is a front view of the locking member of FIG. 2 ;

FIG. 12 is a perspective view of a latch member of FIG. 2 ; and

FIG. 13 is a perspective view of a retaining member of FIG. 2.

### DETAILED DESCRIPTION OF THE DRAWINGS

Reference will now be made in detail to the preferred embodiments of the present invention.

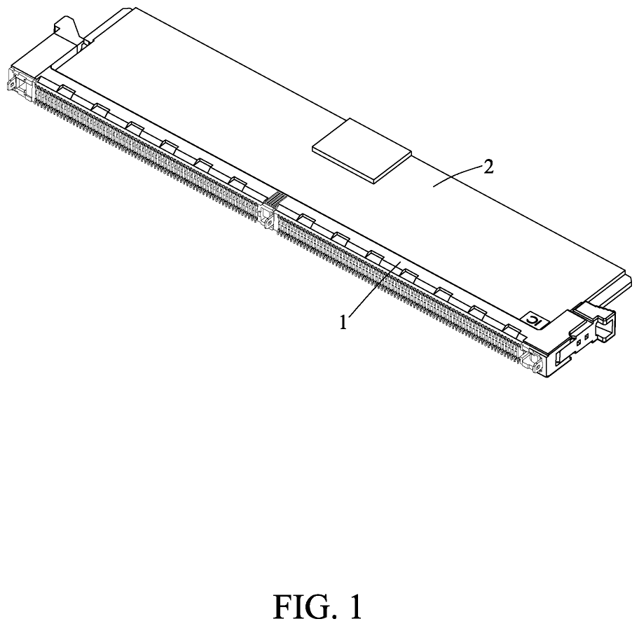

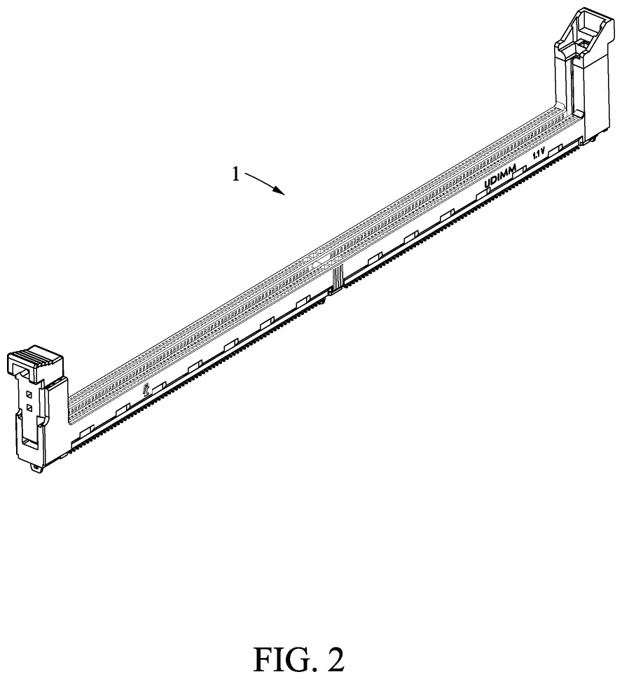

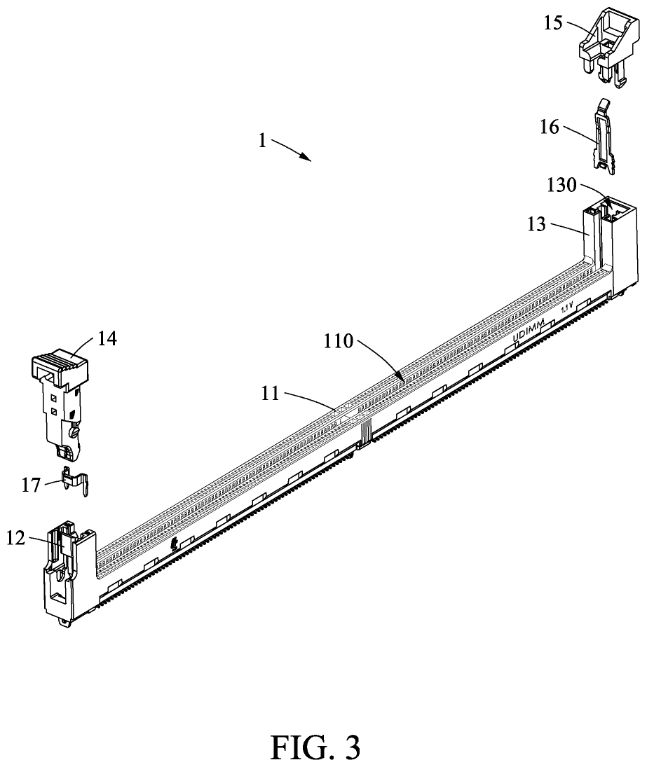

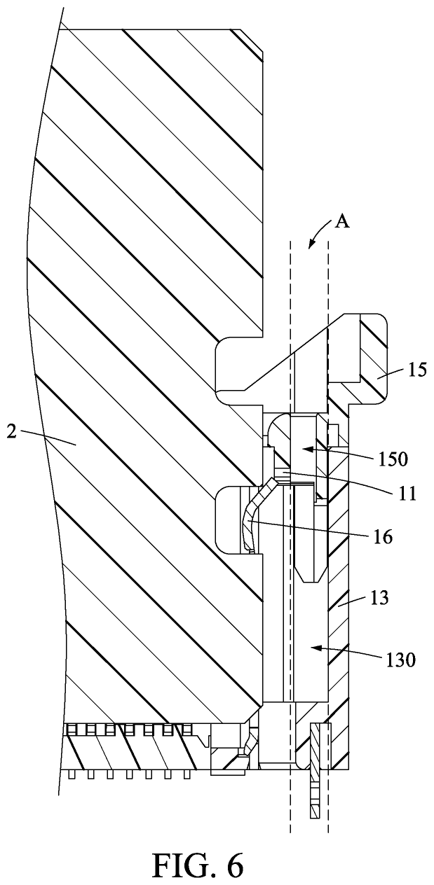

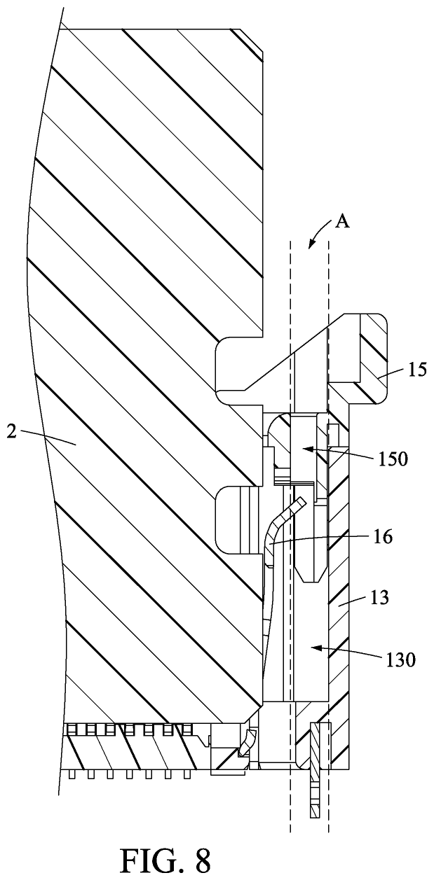

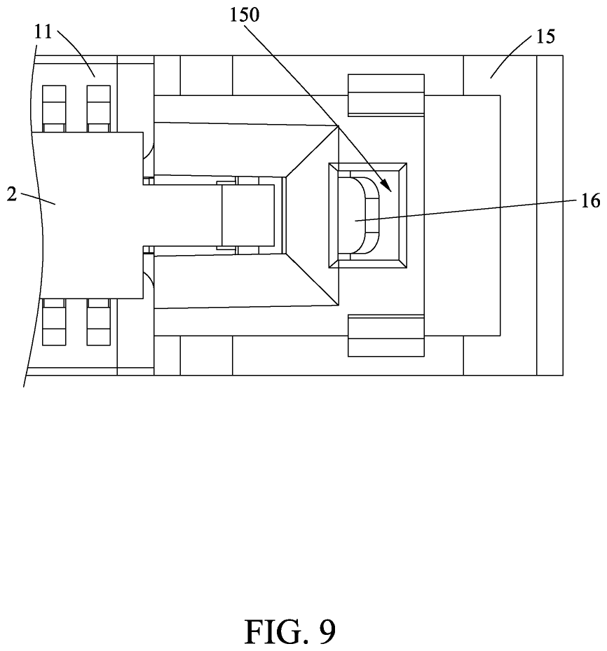

Referring to FIG. 1, a card edge connector 1 is inserted with with an electronic card 2. Referring to FIGS. 2 and 3, the card edge connector 1 includes an elongated insulative housing 11 having a longitudinal direction, a plurality of conductive terminals (not labeled in the figures) received in the insulative housing 11, and a first raised portion 12 and a second raised portion 13 respectively arranged at opposite ends of the insulative housing 11 in the longitudinal direction. The insulative housing 11 has a card slot 110 running through between the first raised portion 12 and the second raised portion 13, the electronic card 2 can be inserted into the card slot. A latch member 14 is pivotally connected to the first raised portion 12, a cover member 15 and a locking member 16 are fixed to the second raised portion 13. A passage 130 extends upwardly from the second raised portion 13 and through the cover member 15. The passage 130 is aligned with card slot 110. The cover member 15 further has an opening 150 communicating with the passages 130. The locking member 16 is fixed in the passage 130 and is movable or deformable in the passage 130 in the longitudinal direction. When the electronic card 2 is inserted into the card slot 110 and the passage 130, opposite edges of the card are locked with the latch member 14 and the locking member 16. As clearly shown in FIG. 8, before the card 2 is fully inserted into the card slot 110 and the passage 130, a part of the locking member is visible through the opening 150 in an inserting direction of the card. After the card is fully inserted, the locking member 15 recovers to lock with the card 2. The part of the locking member disappear from the opening 150 as shown in FIG. 6. If the part of the locking member 16 is permanently seen through the opening 150 as shown in FIGS. 8-9, the user can easily judge the abnormal locked state. Therefore, the abnormal locking state is clearly detected, the opening 150 is a detecting opening, the detecting opening 150 and a part of the passage 130 construct an opening area A as shown in FIG. 6 and FIG. 8.

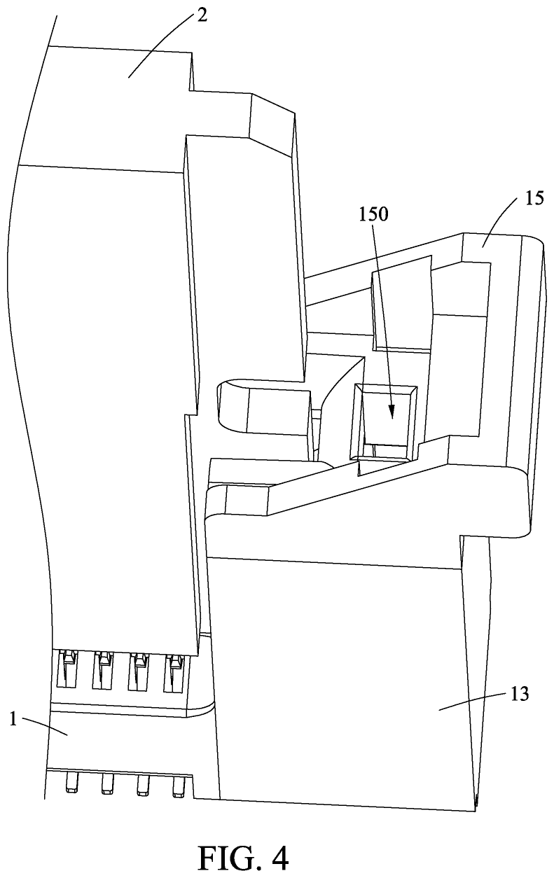

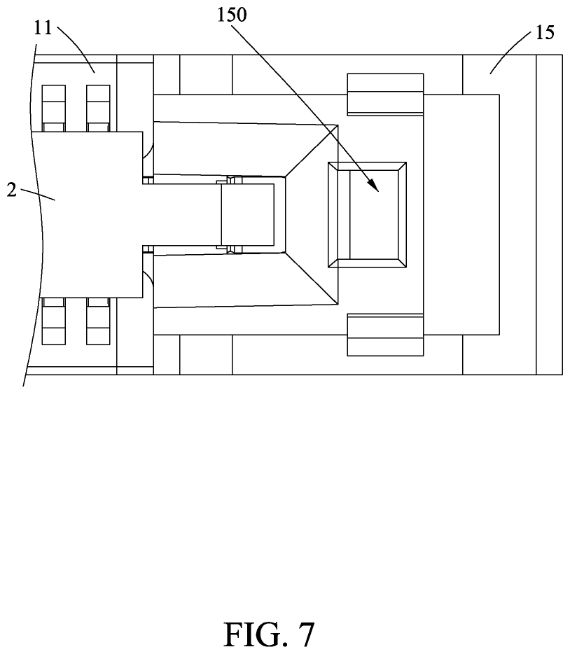

Referring to FIGS. 4 to 7, during an inserting process of the card 2, the locking member 16 deform and enter into the opening area A. The part of the locking member 16 will be seen through the opening 150 by a user. After the card is completed in the card slot 110 and the passage 130, the locking member 15 recover to locking with the card 2. The part of the locking member rebound out of the opening 150 as shown in FIG. 6. As shown in FIGS. 8 and 9, the locking member 16 is pushed to move away from the card slot and into the opening area A, the locking can not recover and the part of the locking member is permanent in the opening area A and is visible through the opening 150. A visualization of the locking status is arrived, allowing the user to directly observe the position of the locking member through the detecting opening and determine whether locking engagement is complete. A hidden risk of false locking due to invisibility in traditional structures is overcome. Moreover, there is no need for external sensors or complex optical devices. A visual function is achieved through improvements via the physical structure, reducing the risk of increased size or cost, and thus achieving a balance between cost and compatibility.

When the locking member 16 exits in the opening 150, the user observes an empty opening and can confirm that locking state is complete, forming visual feedback. The rebound action can produce a distinct “click” tactile sensation, prompting the user that the card is in place, forming tactile feedback. If the locking member 16 does not rebound out of the opening 150, locking failure can be immediately detected, thereby enhancing the prevention of false locking.

The inside of the passage 130 can be arc-shaped to guide the insertion direction of the electronic card 2. The arc-shaped guiding design of the passage 130 fits the movement trajectory of the locking member 16, reducing friction and the risk of jamming, making the locking member 16 operate more smoothly and improving operational smoothness. Additionally, the guiding design ensures that the locking member 16 follows the same path each time, reducing tactile differences caused by deviation and improving force consistency.

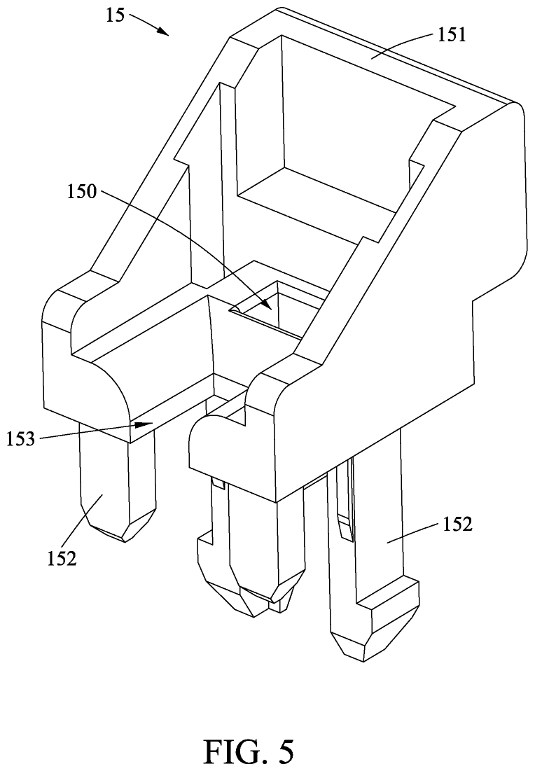

Referring to FIG. 5, the cover member 15 includes a main portion 151, a mounting portion 152 extending downwards from the main portion 151 for being assembled to the second raised portion 13, and an upper passage 153 formed in the main portion 151 and communicating with a lower passage defined on the second raised portion 130 to commonly define the passage 130. The upper passage 153 facilitates the insertion of the electronic card 2, and the opening 150 is located adjacent to the upper passage 153. The cover member 15 can be detachably mounted to the second raised portion 13 via the mounting portion 152, facilitating maintenance. Additionally, the upper passage 153 facilitates the insertion of the electronic card 2, and when the electronic card 2 is inserted, the opening 150 facilitates observation of the locking status.

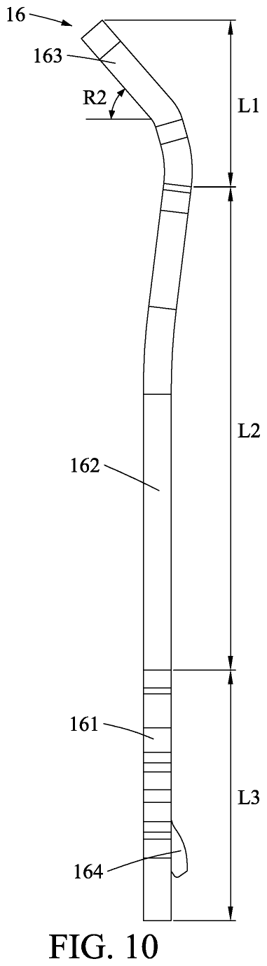

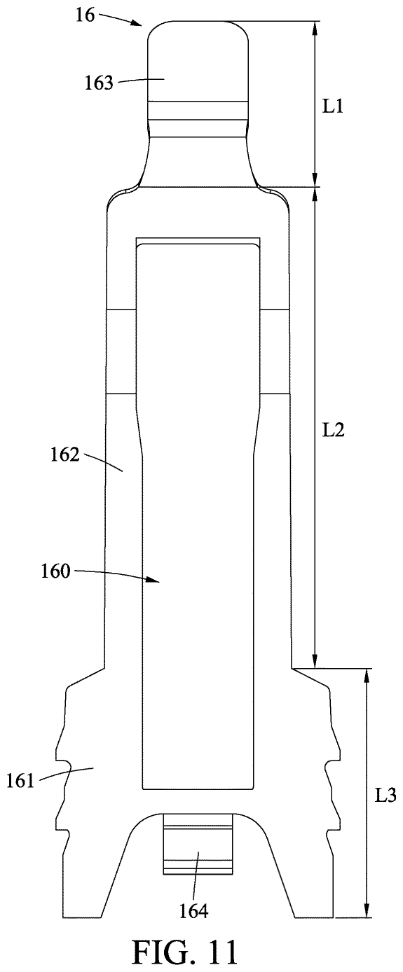

Referring to FIGS. 10 and 11, the locking member 16 can be made from a metal plate and includes a retaining portion 161 fixed to insulating housing, a locking portion 162 extending upward from the retaining portion 161 and inclined toward the card slot 110, and an abut portion 163 extending upward from the locking portion 162 and bent away from the card slot 110. The locking portion 162 includes a locking hole 160 for locking the electronic card. The elastic design of the metal material optimizes the mechanical performance of the locking member 16. That is, the locking member 16 includes a locking arm extending from the retaining portion, the abut portion 163 is a free end of the locking arms, the locking hole 160 is defined on the locking arm. When the electronic card 2 is inserted, the inclined locking hole 160 locks with the electronic card 2 under the combined action of the electronic card 2, the inside of the upper passage 130, and the own elastic force of the locking arm. Meanwhile, the abut portion 163 extends from the upper end of the latch portion 162, the abut portion 163 allows the user to observe the position of the abut portion 163 through the opening 150. If the card is in place, the abut portion 163 does not fall within the opening 150. Otherwise, if the card is abnormal, the abut portion 163 is exposed to the opening 150.

The length or the height of the abut portion 163 is designed to be L1 Therefore, when card is in place, the abut portion 163 does not fall within the opening 150. while when the card is abnormal, the abut portion 163 is exposed to the opening 150. The length of the locking portion 162 is L2, and the length of the retaining portion 161 is L3, with L3:L2 is equal to 1:2. Therefore, the force distribution is optimized, thereby improving the stability and consistency of the locking mechanism.

Additionally, the latch hole 160 extends to the retaining portion 161, and a plurality of protrusions can be provided on both opposite edges of the retaining portion 161. In this embodiment, the extension of the latch hole 160 to the retaining portion 161 can optimize the elastic force of the locking member 16 to a certain extent, thereby improving the effectiveness of locking and rebound. Furthermore, the protrusions enhance fixation stability and improve adaptability in high-frequency insertion and removal scenarios.

As viewed along the insertion direction of the electronic card 2, the latch portion 162 can be inclined toward the card slot 110 at an angle of 5 to 10 degrees relative to the retaining portion 161. Additionally, as viewed along the insertion direction of the electronic card 2, the contact portion 163 can be inclined away from the card slot 110 at an angle of 40 to 45 degrees relative to the retaining portion 161. The angle design of the metal locking member 16 allows the elastic deformation of the metal plate to be controlled at specific angles, ensuring that the user perceives a clear locking threshold, further optimizing force distribution and improving the stability and consistency of the locking mechanism.

Furthermore, the width of the retaining portion 161 can be greater than the width of the latch portion 162, and the width of the latch portion 162 can be greater than the width of the contact portion 163. The width design of the metal locking member 16 allows the wide retaining portion 161 to provide rigid support, while the narrow abut portion 163 reduces friction, balancing strength and elasticity, further optimizing force distribution and improving the stability and consistency of the locking mechanism.

In some embodiments, the retaining portion 161 forms a tab 164 split therefrom and slanting away from the second raised portion 13 to enhance the fixation stability of the locking member 16, reduce displacement-induced false locking, and improve reliability. Additionally, the abut portion 163 can guide the electronic card 2 to be inserted, the abut portion 163 can be a guiding portion

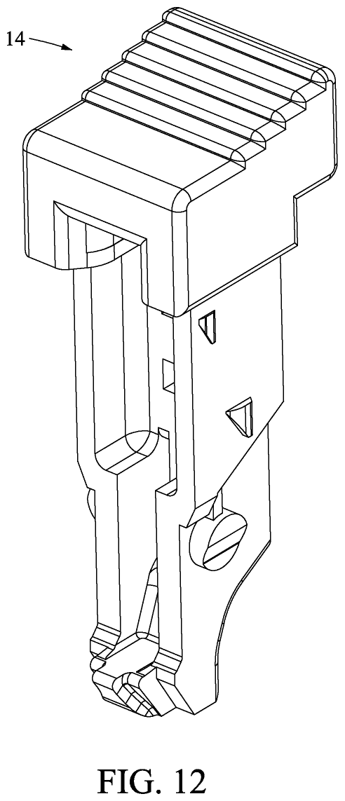

Referring to FIG. 12, the latch member 14 has a head portion at an upper end thereof for convenient pressing by the user and a lower end portion for pivotal connection to the first raised portion 12. The lower end portion is tapered and includes a rotation shaft for rotation in the first raised portion 12 and an inclined slot for unlocking the electronic card 2.

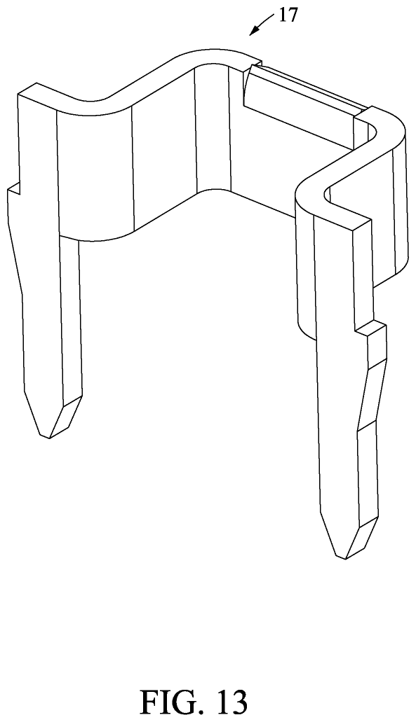

Referring to FIGS. 3 and 13, the card edge connector 1 further includes a retaining member 17 disposed between the first raised portion 12 and the latch member 14. The retaining member is used to reinforce the pivotal connection between the latch member 14 and the first raised portion 12. Therefore, the mechanical strength of the pivot point is enhanced, reducing wobbling of the latch member 14 and ensuring more precise coordinated movement between the latch member and locking member 16 during insertion and removal, thereby reducing locking force deviation caused by structural looseness. Additionally, the retaining member 17 can be concave-shaped to fit the latch member 14, thereby improving the compactness between the latch member 14 and the retaining member 17 and enhancing assembly precision.

However, the disclosure is illustrative only, changes may be made in detail, especially in matter of shape, size, and arrangement of parts within the principles of the invention.

1. A card edge connector comprising:
a longitudinal insulative housing having a longitudinal direction and a card slot for receiving an electronic card;
a plurality of conductive terminals received in the insulative housing;
a first raised portion and a second raised portion respectively extending from opposite ends of the insulative housing;
a latch member pivotally connected to the first raised portion;
a cover member fixed above the second raised portion; and
a locking member fixed in the second raised portion and facing the card slot;
wherein a passage extends from the second raised portion and to the cover member, the cover member has an opening communicating with the passage, the locking member is received in the passage and is deformable in the longitudinal direction, and a part of the locking member is visible through the opening after the locking member deforms away from the card slot in the longitudinal direction.

2. The card edge connector as claimed in claim 1, wherein the locking member has a locking portion to lock with the electronic card and a free end extending away from the card slot in the longitudinal direction, and the free end is visible through the opening after the locking member deforms away from the card slot in the longitudinal direction.

3. The card edge connector as claimed in claim 1, wherein the locking member is made from a metal plate and comprises a retaining portion fixed in the insulative housing, a locking portion extending upward from the retaining portion and inclined toward the card slot, and an abut portion extending upward from the latch portion and bent away from the card slot, and the locking portion has a locking hole for locking with the electronic card.

4. The card edge connector as claimed in claim 3, wherein the locking hole extends to the retaining portion, and the retaining portion has a plurality of protrusions at opposite sides thereof.

5. The card edge connector as claimed in claim 3, wherein the locking portion is inclined toward the card slot at an angle of 5 to 10 degrees relative to the retaining portion.

6. The card edge connector as claimed in claim 3, wherein the abut portion of the locking member is inclined away from the card slot at an angle of 40 to 45 degrees relative to the retaining portion.

7. The card edge connector as claimed in claim 3, wherein a width of the retaining portion is greater than a width of the locking portion, and the width of the locking portion is greater than a width of the abut portion.

8. The card edge connector as claimed in claim 3, wherein the retaining portion has a tab split therefrom to abut against the insulative housing.

9. The card edge connector as claimed in claim 1, further comprising a retaining member disposed between the first raised portion and the latch member.

10. A card edge connector comprising:
an insulative housing having a card slot for receiving an electronic card;
a plurality of conductive terminals disposed in the insulative housing;
a first raised portion and a second raised portion respectively extending from opposite ends of the insulative housing in a longitudinal direction;
a latch member pivotally connected to the first raised portion;
a cover member fixed to the second raised portion and commonly defining a passage aligned with the card slot; and
a locking member comprising a retaining portion fixed to the insulative housing, a locking arm extending upwardly from the retaining portion and inclined toward the card slot in the longitudinal direction, and a guiding portion slantwise extending upward from the locking portion and away from the card slot in the longitudinal direction, the guiding portion being disposed to guide insertion of the electronic card;
wherein the cover member has a detecting opening communicating with the passage, and the guiding portion of the locking member is located in the passage and away from the detecting opening.

11. The card edge connector as claimed in claim 10, wherein the retaining portion has a tab split therefrom to abut against the insulative housing and bends towards the card slot.

12. The card edge connector as claimed in claim 10, wherein the locking member is made from a metal plate and the locking arm has a locking hole for locking with the electronic card.

13. The card edge connector as claimed in claim 10, wherein a height of the locking portion is twice a height of the retaining portion.

14. The card edge connector as claimed in claim 10, wherein the cover member comprises a main portion and two mounting portions retained with the second raised portions, the passage is partly defined on the main body, and the detecting opening is defined adjacent to the passage.

15. A card edge connector comprising:
an insulative housing having a first raised portion, a second raised portion, and a card slot located between the first raised portion and the second raised portion; and
a plurality of conductive terminals disposed in the insulative housing;
a latch member pivotally connected to the first raised portion;
a cover member fixed above the second raised portion; and
a locking member located in the second raised portion and hidden below the cover member, the locking member comprising a retaining portion fixed to the second raised portion, a locking arm extending upwardly from the retaining portion, the locking arm having a locking portion and a free end slanting away from the card slot in the longitudinal direction;
wherein the cover member has an opening, an abnormal locking state is detected when the free end of the locking member is permanently visible through the opening.

16. The card edge connector as claimed in claim 15, wherein the locking arm has a longitudinal locking hole extending in an insertion direction of the electronic card.
